(19) United States
(12) Patent Application Publication
(10) Pub. No.: US 2025/0135540 A1
(43) Pub. Date: May 1, 2025

(54) METHOD AND SYSTEM FOR OPERATING A METAL HYBRID MANUFACTURING SYSTEM TO SHORTEN OBJECT FORMATION TIME

(71) Applicant: ADDiTEC, Palm City, FL (US)

(72) Inventors: Brian Matthews, Palm Beach Gardens, FL (US); Chu-heng Liu, Penfield, NY (US); Paul J. McConville, Webster, NY (US); Sriram Manoharan, West Palm Beach, FL (US)

(21) Appl. No.: 18/498,906

(22) Filed: Oct. 31, 2023

(51) Int. Cl. B22F 10/22; B22F 10/25; B22F 10/30; B22F 10/66; B22F 10/85; B33Y 10/00; B33Y 30/00; B33Y 40/20; B33Y 50/02

(52) U.S. Cl. CPC B22F 10/22; B22F 10/25; B22F 10/30; B22F 10/66; B22F 10/85; B33Y 10/00; B33Y 30/00; B33Y 40/20; B33Y 50/02

(57) ABSTRACT

A metal hybrid manufacturing apparatus includes a melted metal drop ejecting device and a metal deposition device. The melted metal drop ejecting device is operated to form perimeters of layers in a metal object being formed by the system. The metal deposition device is operated to fill interior portions of the layers.

### STATEMENT REGARDING FEDERALLY FUNDED RESEARCH OR DEVELOPMENT

Not Applicable.

### TECHNICAL FIELD

This disclosure is directed to hybrid manufacturing systems that produce three-dimensional (3D) objects and, more particularly, to operation of a metal drop ejecting system and a metal deposition system to form three-dimensional (3D) metal objects.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more ejectors to form successive layers of the plastic material that form a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

3D object printers have been developed that eject drops of melted metal from one or more ejectors to form 3D objects. These devices have a source of solid metal, such as a roll of wire, pellets, billets, or ingots that are fed into a heating chamber where they are melted and the melted metal flows into a chamber of the ejector. The chamber is made of non-conductive material around which an uninsulated electrical wire is wrapped. An electrical current is passed through the conductor to produce an electromagnetic field to cause the meniscus of the melted metal at a nozzle of the chamber to separate from the melted metal within the chamber and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer is also known as a magnetohydrodynamic (MHD) printer or device.

Most melted metal drop ejecting devices have a single ejector that operates at an ejection frequency in a range of about 50 Hz to about 3 KHz and that eject drops having a diameter of about 200 μm to about 700 μm with the higher frequencies usually be used to eject the smaller drops. This firing frequency range and drop size extends the time required to form metal objects over the times needed to form objects made with metal or other alloy materials. Although some melted metal drop ejecting devices have one or more printheads or more than one nozzle fluidly coupled to a common manifold, they still are limited to these ejection frequencies and drop sizes. Three-dimensional object printers having multiple nozzles that form plastic objects and the like are known to use a single nozzle for formation of fine features or the perimeters of layers and then increase the number of nozzles used to infill the layer. By increasing the number of nozzles used, a greater amount of the thermoplastic material can be dispensed into the interior regions of a layer in a short amount of time to improve the production time for the objects manufactured by such printers. Maintaining an adequate supply of melted metal to multiple printheads or nozzles is difficult, especially if the number of nozzles being used is selectively varied during the object formation.

Other additive manufacturing devices have been developed that use deposition techniques for forming layers of a metal object. These systems include metal material supplies and focused heat beams or pneumatic pressure to deposit metal and form metal layers for a metal object. One such metal deposition device is a directed energy deposition (DED) device that typically includes a metal supply channel and a plurality of laser light fibers emanating from a plurality of laser light sources to produce a plurality of off-axis laser light beams that can meet at a focal point of a wire end, metal powder and the laser beams. The plurality of off-axis laser light beams concentrate the laser energy onto the wire and metal powder deposited at the focal point to form a metal spot to produce a layer-by-layer build-up of metal having a user-specified configuration and dimension. User-defined process parameters (e.g., deposition velocity, laser power, and wire/metal powder feed rate) are input into a customized computer process as control signals to drive the metal layer production process. Automated features, including wire feed rate and metal powder deposition rate, provide variable inputs for the optimization of layer quality.

One issue arising from the use of metal deposition devices is the amorphous nature of the metal spot formed by the device in the layer. The metal spot formed in the layer by a metal deposition device is larger than a drop of melted metal ejected by a MHD printer. As a result, a metal deposition device produces a metal layer faster than a MHD printer, however, the size and shape of the metal spot makes the generation of fine features or complex-shaped perimeters more difficult. Additionally, the height of the metal layers produced by a metal deposition device is typically higher than the melted metal drops produced by a MHD printer so combining the layers produced by these different systems to form an object is difficult. Being able to operate additive manufacturing systems in a manner that takes advantage of different metal layer forming characteristics of metal drop ejecting and metal deposition devices would be beneficial.

### SUMMARY

A new metal hybrid manufacturing system enables the melted metal drop ejecting device to form fine features and complex perimeters while the metal deposition device is able to infill the interiors of the features and perimeters more quickly than the melted metal drop ejecting device. The system includes a platform; a first melted metal drop ejecting device configured to eject melted metal drops toward the platform; a metal deposition device that produces metal at a rate that is greater than a rate at which the first melted metal drop ejecting device produces melted metal; and a controller operatively connected to the first melted metal drop ejecting device and the metal deposition device. The controller is configured to: generate a layer model of a metal object to be formed on the platform; using the layer model of the object to identify a perimeter portion of each layer and an interior portion of each layer of the metal object to be formed on the platform; operate the first melted metal drop ejecting device to form the identified perimeter portion of each layer with melted metal drops ejected from the first melted metal drop ejecting device; and operate the metal deposition device to fill the identified interior portion of each layer with metal deposited by the metal deposition device.

A new method of operating a melted metal drop ejecting device and a metal deposition device enables the melted metal drop ejecting device to form fine features and complex perimeters while the metal deposition device is able to infill the interiors of the features and perimeters more quickly than the melted metal drop ejecting device. The method includes generating a layer model of a metal object to be formed on a platform; using the layer model of the object to identify a perimeter portion of each layer and an interior portion of each layer of the metal object to be formed on the platform; operating a first melted metal drop ejecting device to form the identified perimeter portion of each layer with melted metal drops ejected from the first melted metal drop ejecting device; and operating the metal deposition device to fill the identified interior portion of each layer with metal deposited by the metal deposition device.

### BRIEF DESCRIPTION OF THE DRAWINGS

The foregoing aspects and other features of a metal hybrid manufacturing system and its operation that enables the melted metal drop ejecting device to form fine features and complex perimeters while the metal deposition device is able to infill the interiors of the features and perimeters more quickly than the melted metal drop ejecting device are explained in the following description, taken in connection with the accompanying drawings.

FIG. 1A depicts a metal additive manufacturing system that operates a melted metal drop ejecting device to form fine features and complex perimeters while a metal deposition device is operated to infill the interiors of the features and perimeters more quickly than the melted metal drop ejecting device.

FIG. 1B depicts an alternative embodiment of metal additive manufacturing system that operates a first melted metal drop ejecting device to form fine features and complex perimeters while a second melted metal drop ejecting device that produces drops having a larger volume than the drops produced by the first melted metal drop ejecting device is operated to infill the interiors of the features and perimeters more quickly than the first metal drop ejecting device.

FIG. 2 depicts the use of the metal hybrid manufacturing system of FIG. 1A to form a metal layer of an object.

FIG. 3 depicts the use of the metal hybrid manufacturing system of FIG. 1B to form a metal layer of an object.

FIG. 4 is a flow diagram of a process that operates the metal hybrid manufacturing systems of FIG. 1A and FIG. 1B to form layers in metal objects more quickly.

### DETAILED DESCRIPTION

For a general understanding of the environment for the system and its operation as disclosed herein as well as the details for the device and its operation, reference is made to the drawings. In the drawings, like reference numerals designate like elements.

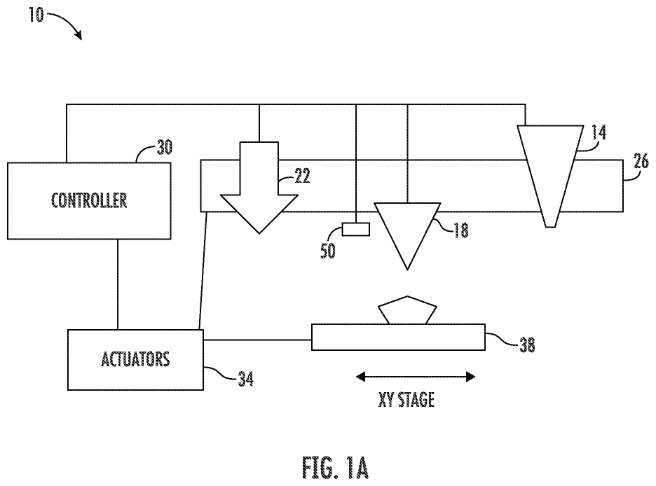

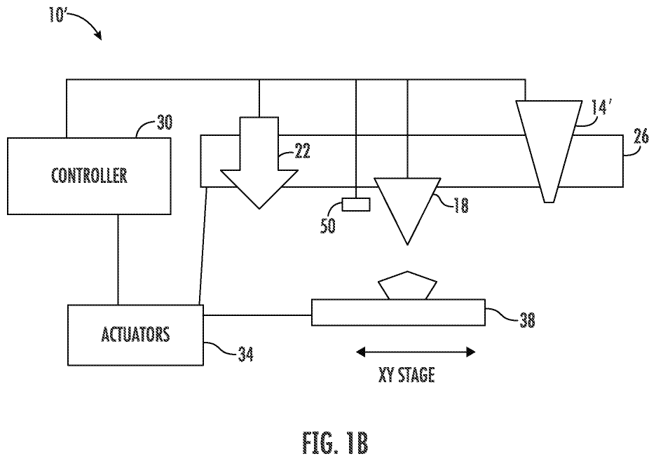

FIG. 1A illustrates an embodiment of a metal hybrid manufacturing system 10 that includes a metal deposition device 14, such as a DED device, a melted metal drop ejecting device 18, and a subtractive manufacturing device 22. These devices are mounted on a common frame or gantry 26. As used in this document, the term “metal deposition device” means an assembly of components that selectively deposits metal on a substrate or object and causes the deposited metal to bond to the substrate or object simultaneously or instantaneously. As used in this document, the term “melted metal drop ejecting device” means an assembly of components that melts solid metal and ejects discrete drops of the melted metal onto a substrate or object. Examples of this melted metal drop ejecting device may include, a conventional magnetohydrodynamic (MHD) ejector, an inductive MHD ejector, an electrohydrodynamic (EHD) liquid metal ejector, a mechanical or piezo-coupled piston driven ejector, and a pneumatic ejector. As used in this document, the term “subtractive manufacturing device” means a tool that is configured to remove material from an object being formed by an additive manufacturing device. A subtractive manufacturing device may be drill bit, a lathe, or other known computer numerical control (CNC) device. A controller 30 is operatively connected to the devices 14, 18, and 22. The controller 30 includes a computer-readable, non-transitory storage media, such as an internal memory, or an external computer-readable, non-transitory storage media, such as electronic memory or the like, that stores programmed instructions that when executed by the controller cause the controller to operate the devices in a manner described more fully below. The controller 30 is also operatively connected to one or more actuators 34 that are operatively connected to the frame 26 and the platform 38. The controller 30 operates the one or more actuators 34 to move the platform 38 in an X-Y plane and move the frame 26 bidirectionally along a Z axis that is perpendicular to the X-Y plane when the controller executes programmed instructions in the internal or external memories.

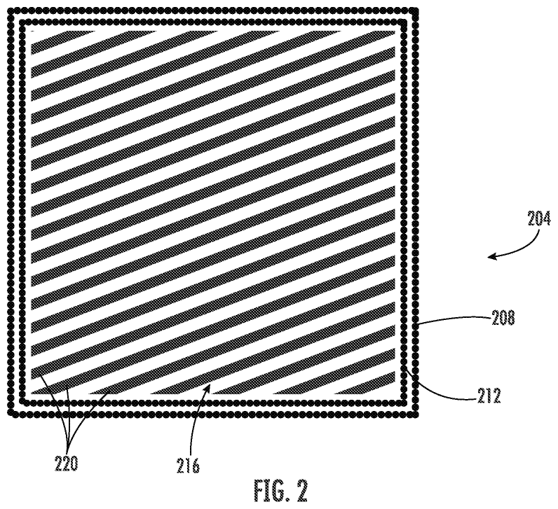

In order to expedite the production of metal objects with the metal hybrid manufacturing system 10 of FIG. 1A, the system is configured to operate the metal deposition device 14 and the metal drop ejecting device 18 for specific tasks that take advantage of the characteristics of the two devices. One method of operating these devices is explained with reference to FIG. 2. In the figure, one layer 204 of a metal object is shown. The outer perimeter 208 of the layer 204 is formed with the controller 30 operating the metal drop ejecting device 18 with a first drop volume and first ejection frequency. As depicted in the figure, these drops are smaller than the drops forming an inner perimeter 212 and are adjacent to one another. Thus, the outer perimeter is smoother and more integrated than the inner perimeter. The second drop volume at which the controller operates the metal ejecting device 18 to form the inner perimeter 212 is larger than the first drop volume. This difference in volumes permits the inner perimeter 208 to be formed more quickly than the outer perimeter 208 but the inner perimeter has a rougher surface. Additionally, the second ejection frequency at which the controller operates the metal ejecting device 18 is less than the first ejection frequency. Once the outer and inner perimeters are formed, the interior region 216 of the metal layer needs to be filled. Rather than using the metal ejecting device 18 to perform this task, the controller operates the actuators 34 to move the metal ejecting device 18 away from the metal layer being formed and moves the metal deposition device 14 to one corner of the interior region. Then controller then operates the actuators 34 to move the metal deposition device 14 bidirectionally over the interior region while also operating the metal deposition device to form streams 220 of metal that infill the interior region. These streams of metal fill the interior region 216 more quickly than would ejected metal drops from the metal drop ejecting device 18. Thus, the metal hybrid manufacturing system 10 forms a metal object layer with a perimeter that is smooth and sufficiently strong to contain the streams of metal used to fill the interior region and to form the layer more expeditiously than use of a metal drop ejecting device alone or a metal deposition device alone. While the metal hybrid manufacturing system 10 has been described as using a DED device for the metal deposition device 14, the reader should understand that metal extruders, an electrical wire welding device (sometimes called a Joule printing device), or a cold spray metal deposition device can be used as well.

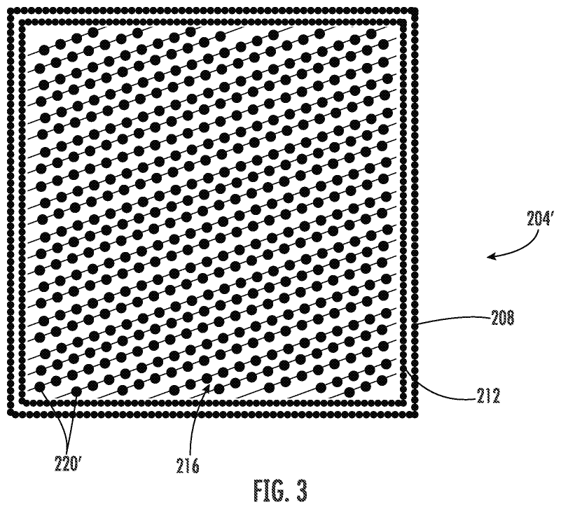

A method of operating the metal hybrid manufacturing system 10′ to form a metal layer 204 is explained with reference to FIG. 3. This metal layer is formed with an alternative embodiment of the metal hybrid manufacturing system shown in FIG. 1B. In this figure, a second melted metal drop ejecting device 14′ has been mounted to the frame 26 as a substitute for the metal deposition device 14. The device 14′ ejects melted metal drops having a larger volume than the drops ejected by the melted metal drop ejecting device 18. Using the system 10′, the outer perimeter 208 and the inner perimeter 212 of the layer 204 of FIG. 3 are formed as described above with reference to FIG. 2. Then rather than using the metal deposition device 14 to infill the interior region 216, the controller operates the actuators 34 to move the melted metal ejecting device 18 away from the metal layer being formed and moves the second melted metal drop ejecting device 14′ bidirectionally over the interior region while also operating the second melted metal drop ejecting device 14′ to form streams 220′ of metal that infill the interior region. The second melted metal drop ejecting device 14′ in this embodiment is implemented with a device that ejects melted metal drops having a larger volume than the drops ejected by the melted metal drop ejecting device 18 so these streams fill the interior region 216 more quickly than the ejected metal drops from the melted metal drop ejecting device 18. The second melted metal drop ejecting device 14′ can be, for example, a pneumatic melted metal drop device, a mechanical or piezo-coupled piston driven ejector, an EHD liquid metal ejector, and a MHD liquid metal ejector. Furthermore, this second melted metal drop ejecting device can be the same kind of device as the first melted metal drop ejecting device, but optimized with hardware and a software parameter set to operate with larger drops and higher throughput. Again, the metal hybrid manufacturing system 10′ that includes a second metal drop ejecting device 14′ forms a metal object layer with a perimeter that is smooth and sufficiently strong to contain the streams of metal used to fill the interior region and to form the layer more expeditiously than use of the metal drop ejecting device 18 alone or the second metal drop ejecting device alone.

The metal hybrid manufacturing systems 10 and 10′ can have various options for the printing order of the perimeter and interior portions. For example, in each layer, the perimeter portions can be printed first, the interior portions printed first, or the printing of the perimeter and interior portions can be interspersed. These variations in the printing of the different portions can be optimized for various purposes. For example, to minimize tool switching, the order can be switched for every layer to allow one printing device to be used continuously for two consecutive layers. For example, for a layer i, the perimeter portions can be printed first followed by the interior portions. When the object build process advances to next layer i+1, the interior portions can be printed without switching out the deposition device. Following the formation of the interior portions, the metal deposition device is switched out for the metal drop ejecting device and the perimeter portions of layer i+1 are printed. This type of switching enables the tool/device switching to be reduced by 50%.

The metal hybrid manufacturing systems 10 and 10′ also enable the use of one material for perimeter formation and another material for infill formation. For example, the melted metal drop ejecting device 18 used to form the outer and inner perimeters shown in FIG. 2 ejects melted metal drops of pure aluminum while the metal deposition device 14 forms the streams with an aluminum alloy, such as Al 6061. The pure aluminum will be more corrosion resistant to serve as the outer layer while the Al6061 is much stronger to provide desired mechanical properties. Additionally, the final layer of the object is better formed using the melted metal drops ejected from the melted metal drop ejecting device since the smaller volume melted metal drops from this device and the higher resolution of the placement of those drops result in a smoother finish. Also, the exterior/surface quality is improved by the material composition of the ejected drops.

In another embodiment, the part building process can be optimized by using different materials for the infill and perimeter advantageously. For example, the perimeter material in this particular embodiment enables the perimeter to be formed with a material that has a higher melting point than the material used to fill the interior region of the layer. This embodiment can also use the printing order optimization noted above to enhance the build quality. Thus, the perimeter holds its shape better while the interior is being filled since the perimeter acts as a containing wall so the infill material can thoroughly liquify for better bonding without distorting the part.

In other embodiments of the systems 10 and 10′, an optical sensor 50 is included in the system. This optical sensor 50 may be mounted to the frame 26 as shown in FIG. 1A and FIG. 1B. The optical sensor 50 may be a digital camera, a profilometer, or an array of photo detectors that receive and process reflected light. The controller 30 is configured with programmed instruction stored in a computer-readable, non-transitory media that when executed by the controller cause the controller to process image data from the optical sensor 50 and measure differences in the heights between the different portions of a layer. In particular, the perimeter and the infill may have different build rates due to differences in devices and technologies despite efforts, such as calibrations and optimizations of operating parameters, to minimize the layer thickness differences between interior and perimeter portions. If these differences exceed a predetermined threshold, the controller 30 executes programmed instructions that cause the controller to modify the layer printing instructions for the subsequent layers to compensate for the deviations from the specified heights. For example, parameters identified in the layer printing instructions, such as drop spacing, line spacing, drop ejection frequency, linear speed, feed rate of the solid metal, and the like can be adjusted to increase or decrease the material deposition at a given location or a region. Alternatively, the controller 30 executes programmed instructions that cause the controller to operate the actuators 34 and the subtractive manufacturing device 22 to remove material from the higher region to bring the height difference within tolerance. As a further alternative, the build rates can be intentionally set to be greater than the rate identified in the parameters of the layer printing instructions to produce excessive deposition in all portions of one or more layers. The subtractive tool can then be employed at regular intervals, even every layer, to bring the height of the object within specification.

The controller 30 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During electronic device formation, image data for a structure to be produced are sent to the processor or processors for controller 30 from either a scanning system or an online or work station connection for processing and generation of the control signals used to operate the devices of systems 10 and 10′.

The controller 30 of the metal hybrid manufacturing systems 10 and 10′ require data from external sources to control the devices of the systems for 3D metal object manufacture. In general, a three-dimensional model or other digital data model of the device to be formed is stored in a non-transitory storage media operatively connected to the controller 30, the controller can access through a server or the like a remote database in which the digital data model is stored, or a computer-readable non-transitory medium in which the digital data model is stored can be selectively coupled to the controller 136 for access. A known program, sometimes called a slicer, forms a layer model of the object to be manufactured using the digital data model. The layer model identifies the exterior portions of the layers of the object and the interior regions of the layers. The layer model is used by the controller to generate machine-ready instructions for execution by the controller 30 in a known manner to operate the components of the systems 10 and 10′ and form the metal object corresponding to the layer model. The generation of the machine-ready instructions can include the production of intermediate models, such as when a CAD model of the object is converted into an STL data model, or other polygonal mesh or other intermediate representation, which can in turn be processed to generate machine-ready instructions, such as g-code for fabrication of the device by the printer. As used in this document, the term “machine-ready instructions” means computer language commands that are executed by a computer, microprocessor, or controller to operate components of a metal hybrid manufacturing system to form metal objects. The controller 30 executes the machine-ready instructions to control the operations of the devices 14, 18, 22, and 14′, the actuators 34 for positioning of the frame 26 and the platform 38 including the distance between the devices being operated to form layers of an object and the uppermost layer of the object on the platform 38.

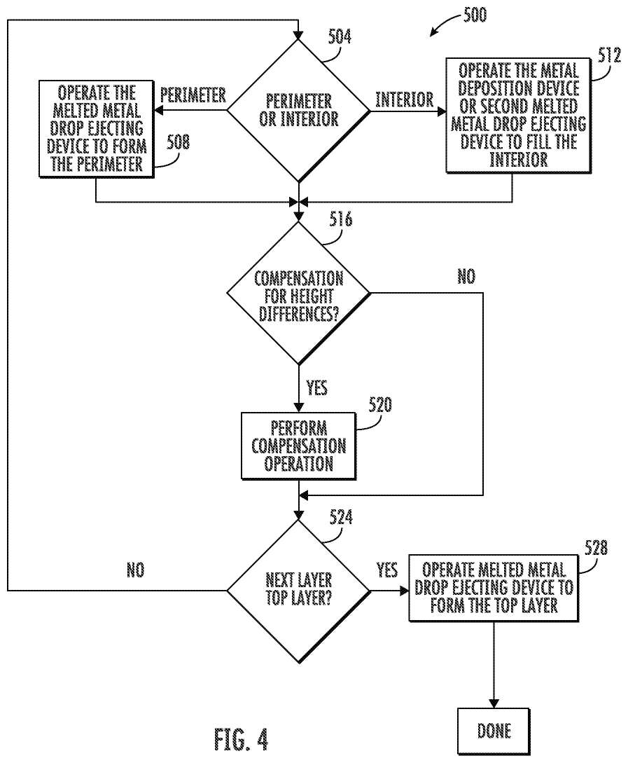

A process for operating the systems 10 and 10′ shown in FIG. 1A and FIG. 1B is shown in FIG. 4. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 30 noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 4 is a flow diagram 500 of a process that operates the system 10 and 10′ to metal objects more quickly. The process begins by identifying whether a portion for a layer to be printed in the object is a perimeter or interior portion (block 504). For perimeter formation, the melted metal drop ejecting device is operated to form the perimeter portion (block 508). If the portion to be formed is an interior portion, then the metal deposition device 14 or the second melted metal drop ejecting device 14′, depending on the system being controlled, is operated to fill the interior region (block 512). The process then determines whether compensation is required for height differences between the infill regions and the printed perimeters (block 516). If compensation is needed, then a compensation operation is performed to attenuate the height differences as noted previously (block 520). The process determines if the next layer is the top surface of the object (block 524). If it is, then the melted metal drop ejecting device is operated to form the top layer (528). The process continues until the top surface is formed (block 528) and the object is finished (block 532).

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal hybrid manufacturing system comprising:
a platform;
a first melted metal drop ejecting device configured to eject melted metal drops toward the platform;
a metal deposition device that produces metal at a rate that is greater than a rate at which the first melted metal drop ejecting device produces melted metal; and
a controller operatively connected to the first melted metal drop ejecting device and the metal deposition device, the controller being configured to:
generate a layer model of a metal object to be formed on the platform;
using the layer model of the object to identify a perimeter portion of each layer and an interior portion of each layer of the metal object to be formed on the platform;
operate the first melted metal drop ejecting device to form the identified perimeter portion of each layer with melted metal drops ejected from the first melted metal drop ejecting device; and
operate the metal deposition device to fill the identified interior portion of each layer with metal deposited by the metal deposition device.

2. The metal hybrid manufacturing system of claim 1 wherein the metal deposition device is one of a directed energy deposition device, a melted metal extrusion device, and a wire welding device.

3. The metal hybrid manufacturing system of claim 1 wherein the metal deposition device is a second melted metal drop ejecting device that produces melted metal drops that are larger than the melted metal drops produced by the first melted metal drop ejecting device.

4. The metal hybrid manufacturing system of claim 1 wherein the first melted metal drop ejecting device is one of a magnetohydrodynamic device, an electrohydrodynamic ejector, a piston driven ejector, and a pneumatic ejector.

5. The metal hybrid manufacturing system of claim 1 wherein the first melted metal drop ejecting device is configured to eject melted drops of a first metal and the metal deposition device is configured to emit a stream of a second metal that is different than the first metal.

6. The metal hybrid manufacturing system of claim 1 further comprising:
an optical sensor configured to generate image data of an upper surface of the metal object being formed on the platform; and
the controller being further configured to:
identify a difference in height between portions of a formed layer of an upper surface of the metal object and a height identified in the layer model;
compare the identified difference to a predetermined threshold; and
compensate for the height differences in response to the identified difference being greater than the predetermined threshold.

7. The metal hybrid manufacturing system of claim 6, the controller being further configured to compensate for the height differences by:
modifying layer printing instructions for subsequent layers in the layer model.

8. The metal hybrid manufacturing system of claim 7, the controller being further configured to modify the layer printing instructions by changing one or more of a drop spacing, a line spacing, a drop ejection frequency, an linear speed and a solid metal feed rate identified in the layer printing instructions.

9. The metal hybrid manufacturing system of claim 6 further comprising:
a subtractive manufacturing device; and
the controller is further configured to compensate for the height differences by:
operating the subtractive manufacturing device to remove material from a higher portion of the formed layer.

10. The metal hybrid manufacturing system of claim 9 wherein the subtractive manufacturing tool is a computer numerical control (CNC) tool.

11. A method for operating a metal hybrid manufacturing system comprising:
generating a layer model of a metal object to be formed on a platform;
using the layer model of the object to identify a perimeter portion of each layer and an interior portion of each layer of the metal object to be formed on the platform;
operating a first melted metal drop ejecting device to form the identified perimeter portion of each layer with melted metal drops ejected from the first melted metal drop ejecting device; and
operating the metal deposition device to fill the identified interior portion of each layer with metal deposited by the metal deposition device.

12. The method of operating the metal hybrid manufacturing system of claim 11, the operating of the metal deposition device further comprising:
operating a directed energy deposition device.

13. The method of operating the metal hybrid manufacturing system of claim 11, the operating of the metal deposition device further comprising:
operating a second melted metal drop ejecting device that produces melted metal drops that are larger than the melted metal drops produced by the first melted metal drop ejecting device.

14. The method of operating the metal hybrid manufacturing system of claim 11, the operating of the first melted metal drop ejecting device further comprising:
operating a magnetohydrodynamic device.

15. The method of operating the metal hybrid manufacturing system of claim 11 wherein operation of the first melted metal drop ejecting device ejects melted drops of a first metal and operation of the metal deposition device emits a stream of a second metal that is different than the first metal.

16. The method of operating the metal hybrid manufacturing system of claim 11 further comprising:
identifying a difference in height between portions of a formed layer of an upper surface of the metal object and a height identified in the layer model;
comparing the identified difference to a predetermined threshold; and
compensating for the identified difference in response to the identified difference being greater than the predetermined threshold.

17. The method of operating the metal hybrid manufacturing system of claim 16, the compensation for the identified difference further comprising:
modifying layer printing instructions for subsequent layers in the layer model.

18. The method of operating the metal hybrid manufacturing system of claim 17, the modification of the layer printing instructions further comprising:
changing one or more of a drop spacing, a line spacing, a drop ejection frequency, a linear speed, and a solid metal feed rate identified in the layer printing instructions.

19. The method of operating the metal hybrid manufacturing system of claim 16, the compensation of the identified difference further comprising:
operating a subtractive manufacturing device to remove material from a higher portion of the formed layer.

20. The method of operating the metal hybrid manufacturing system of claim 19, the operation of the subtractive manufacturing device further comprising:
operating a computer numerical control (CNC) tool to remove the material.
